(19) United States
(12) Patent Application Publication
(10) Pub. No.: US 2025/0078423 A1
(43) Pub. Date: Mar. 6, 2025

(54) PASSTHROUGH VIEWING OF REAL-WORLD ENVIRONMENT FOR EXTENDED REALITY HEADSET TO SUPPORT USER SAFETY AND IMMERSION

(71) Applicant: Samsung Electronics Co., Ltd., Suwon-si, Gyeonggi-do (KR)

(72) Inventors: Edgar C. Evangelista, San Jose, CA (US); Hiroshi Horii, Pleasanton, CA (US); Ajinkya Waghulde, Castro Valley, CA (US); Yujie Jiang, Santa Clara, CA (US)

(21) Appl. No.: 18/808,619

(22) Filed: Aug. 19, 2024

Related U.S. Application Data
(60) Provisional application No. 63/536,343, filed on Sep. 1, 2023.

(51) Int. Cl. G06T 19/00; G06T 19/20

(52) U.S. Cl. CPC G06T 19/006; G06T 19/20; G06T 2219/2016; G06T 2219/2021

(57) ABSTRACT

A method includes obtaining real-time video captured using one or more imaging sensors of an immersive headset. The method also includes processing the real-time video to identify one or more real-world objects and render the one or more real-world objects on at least one display of the immersive headset. The method further includes allowing a user of the immersive headset to select at least one of the one or more real-world objects or at least one spatial volume containing the at least one real-world object. The method still further includes displaying an extended reality view on the at least one display while overlaying, on the extended reality view, a representation of at least a portion of the at least one real-world object or the at least one spatial volume in one of multiple modes that each show the representation differently.

### CROSS-REFERENCE TO RELATED APPLICATION AND PRIORITY CLAIM

This application claims priority under 35 U.S.C. § 119 (e) to U.S. Provisional Patent Application No. 63/536,343 filed on Sep. 1, 2023, which is hereby incorporated by reference in its entirety.

### TECHNICAL FIELD

This disclosure relates generally to extended reality (XR) systems and processes. More specifically, this disclosure relates to passthrough viewing of a real-world environment for an XR headset to support user safety and immersion.

### BACKGROUND

Virtual reality (VR) and other extended reality (XR) technologies have seen rapid advancements in recent years, in some cases allowing users to be immersed in fully-digital or computer-simulated environments. While these environments can be richly detailed and engaging, users are often completely isolated from the real world around them when wearing XR headsets. This isolation can lead to potential safety issues, especially if the user needs to move in a physical space or if there are obstacles or other individuals nearby.

### SUMMARY

This disclosure relates to passthrough viewing of a real-world environment for an extended reality headset to support user safety and immersion.

In a first embodiment, a method includes obtaining real-time video captured using one or more imaging sensors of an immersive headset. The method also includes processing the real-time video to identify one or more real-world objects and render the one or more real-world objects on at least one display of the immersive headset. The method further includes allowing a user of the immersive headset to select at least one of the one or more real-world objects or at least one spatial volume containing the at least one real-world object. In addition, the method includes displaying an extended reality view on the at least one display while overlaying, on the extended reality view, a representation of at least a portion of the at least one real-world object or the at least one spatial volume in one of multiple modes that each show the representation differently.

In a second embodiment, an electronic device includes one or more imaging sensors, at least one display, and at least one processing device. The at least one processing device is configured to obtain real-time video captured using the one or more imaging sensors. The at least one processing device is also configured to process the real-time video to identify one or more real-world objects and render the one or more real-world objects on the at least one display. The at least one processing device is further configured to allow a user to select at least one of the one or more real-world objects or at least one spatial volume containing the at least one real-world object. In addition, the at least one processing device is configured to initiate display of an extended reality view on the at least one display while overlaying, on the extended reality view, a representation of at least a portion of the at least one real-world object or the at least one spatial volume in one of multiple modes that each show the representation differently.

In a third embodiment, a non-transitory machine readable medium contains instructions that when executed cause at least one processor of an electronic device to obtain real-time video captured using one or more imaging sensors. The non-transitory machine readable medium also contains instructions that when executed cause the at least one processor to process the real-time video to identify one or more real-world objects and render the one or more real-world objects on at least one display. The non-transitory machine readable medium further contains instructions that when executed cause the at least one processor to allow a user to select at least one of the one or more real-world objects or at least one spatial volume containing the at least one real-world object. In addition, the non-transitory machine readable medium contains instructions that when executed cause the at least one processor to initiate display of an extended reality view on the at least one display while overlaying, on the extended reality view, a representation of at least a portion of the at least one real-world object or the at least one spatial volume in one of multiple modes that each show the representation differently.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration providing a passthrough view of obstacles in a surrounding real-world environment for an immersive headset user in accordance with this disclosure;

FIGS. 2A through 2C illustrate, using images representing a real-world environment for an immersive headset user, an example provision of a passthrough view of the surrounding real-world environment in accordance with this disclosure;

FIGS. 3A through 3C illustrate, using images representing a real-world environment for an immersive headset user, an example object registration for provision of a passthrough view of the surrounding real-world environment in accordance with this disclosure;

FIGS. 4A through 4C illustrate, using images representing an immersive reality overlay on a real-world environment, an example manual placement of a volume on an object in a real-world environment in accordance with this disclosure;

FIGS. 5A through 5C illustrate an example shape modification during manual placement of a spatial volume (FIG. 3A) and an example modification of a suggested spatial volume (FIG. 3B) overlaid on a real-world object in accordance with this disclosure;

FIGS. 6A through 6C illustrate an example shape recognition for a real-world object in accordance with this disclosure;

FIG. 7 illustrates example training and deployment of a machine learning model for shape recognition of a real-world object in accordance with this disclosure;

FIG. 8 illustrates example spatial volumes for provision of a passthrough view of objects in a real-world environment following object registration in accordance with this disclosure;

FIGS. 9A and 9B illustrate, using images representing a real-world environment for an immersive headset user, example spatial volume activations for provision of a passthrough view of the surrounding real-world environment in accordance with this disclosure;

FIGS. 10A through 10C illustrate an example toggling spatial volume activation for a passthrough view of objects in the surrounding real-world environment in accordance with this disclosure;

FIGS. 11A through 11C illustrate, using images representing an immersive environment, an example tracking of real-world objects for provision of a passthrough view in accordance with this disclosure;

FIG. 12 illustrates example immersion safety modes for a passthrough view of real-world objects in an immersive environment in accordance with this disclosure;

FIGS. 13A and 13B illustrate, using images representing an immersive environment, an example passthrough view of obstacles in the real-world environment surrounding an immersive headset user while in a safe immersion safety mode in accordance with this disclosure;

FIGS. 14A and 14B illustrate, using images representing an immersive environment, an example passthrough view of obstacles in the real-world environment surrounding an immersive headset user while in a balanced immersion safety mode in accordance with this disclosure;

FIGS. 15A and 15B illustrate, using images representing an immersive environment, an example passthrough view of obstacles in the real-world environment surrounding an immersive headset user while in a moderate immersion safety mode in accordance with this disclosure;

FIG. 16 illustrates an example process for providing a passthrough view of obstacles in the surrounding real-world environment for an immersive headset user in accordance with this disclosure; and

FIG. 17 illustrates another example process for providing a passthrough view of obstacles in the surrounding real-world environment for an immersive headset user in accordance with this disclosure.

### DETAILED DESCRIPTION

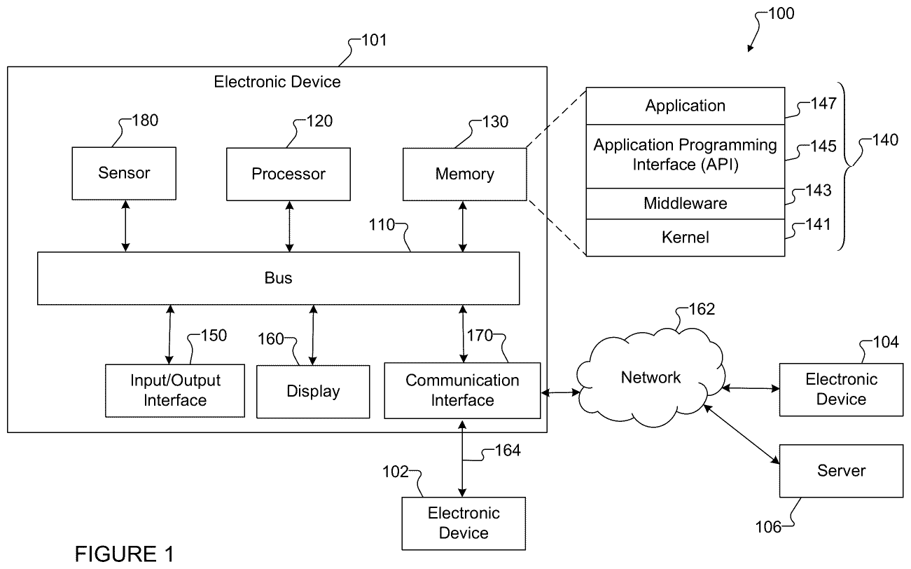

FIGS. 1 through 17, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, virtual reality (VR) and other extended reality (XR) technologies have seen rapid advancements in recent years, in some cases allowing users to be immersed in fully-digital or computer-simulated environments. While these environments can be richly detailed and engaging, users are often completely isolated from the real world around them when wearing XR headsets. This isolation can lead to potential safety issues, especially if the user needs to move in a physical space or if there are obstacles or other individuals nearby.

In some approaches, users of XR headsets can set boundaries outlining obstacles within physical spaces being used. However, this requires quite a lot of open floor space to stop users from hurting themselves, others, or their physical property when using the XR headsets. Also, the boundaries usually do not normally include certain furniture pieces that the users may want to include, such as desks, chairs, and couches (which are items that may make the users' experience more comfortable and productive). To utilize a space that is not completely open, a user would typically have to allow the XR experience to occur in a space with furniture and/or obstacles that may reduce the user's safety.

Moreover, current systems do not understand spaces well enough to provide for furniture or obstacles but rather exclude structures that seem to be obstacles, even if recognized by the systems. If obstacles are included within a boundary, the obstacles are commonly unrecognized by an XR system, creating further user safety issues. If obstacles are outlined using current boundary methods, a user may encounter boundary visualizations that reduce the immersion experience. Thus, there are often opposing needs involving user immersion and user safety.

This disclosure provides various techniques for passthrough viewing of a real-world environment for a VR headset to support user safety and immersion. These techniques allow a user to utilize a space that is not completely open and to include desired furniture or other obstacles in order to enable a safer and/or more comfortable VR or other XR experiences. These techniques can therefore be used to (i) better understand the space, (ii) track the positions of the obstacles in the space, and (iii) alert the user when the user is near an obstacle.

Various approaches are proposed here for understanding obstacles within a user's space, depending on the technical capabilities of the XR system. These approaches can be referred to as a form of “object registration,” where the system registers objects in the user's space. For example, one object registration approach provides a user interface for a user to manually place one or more volumes that enclose one or more obstacles within a space. Another object registration approach uses computer vision and machine learning to understand the space and suggest simplified volumes that the user may accept or modify. Yet another object registration approach completely relies on computer vision and machine learning to place one or more volumes within the space. Each volume can be referred to here as a “spatial volume,” which defines a three-dimensional (3D) space within the user's space tracked by the system.

In order to alert the user about furniture or other obstacles, several modes are proposed that weigh user immersion versus user safety and visualize the obstacles in different ways using a passthrough cutout capabilities of a passthrough-capable XR system. For example, in some embodiments, the following modes may be supported.
Safe Mode—the user may see a passthrough cutout of an obstacle starting from a farther distance than other modes.
Balanced Mode—the user may start to see a passthrough cutout of an obstacle starting from a closer distance.
Moderate Mode—the user may only see an outline of an obstacle using a filtered image of a passthrough cutout, thereby increasing immersion.
Off-the system is not actively providing outlines or passthrough cutouts, striving to ensure the user is completely immersed while in the space.

FIG. 1 illustrates an example network configuration 100 providing a passthrough view of obstacles in a surrounding real-world environment for an immersive headset user in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to passthrough viewing of a real-world environment for an XR headset to support user safety and immersion.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to passthrough viewing of a real-world environment for an XR headset to support user safety and immersion. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high-definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or a VR or other XR headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to passthrough viewing of a real-world environment for an XR headset to support user safety and immersion.

Although FIG. 1 illustrates one example of a network configuration 100 providing a passthrough view of obstacles in a surrounding real-world environment for an immersive headset user, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

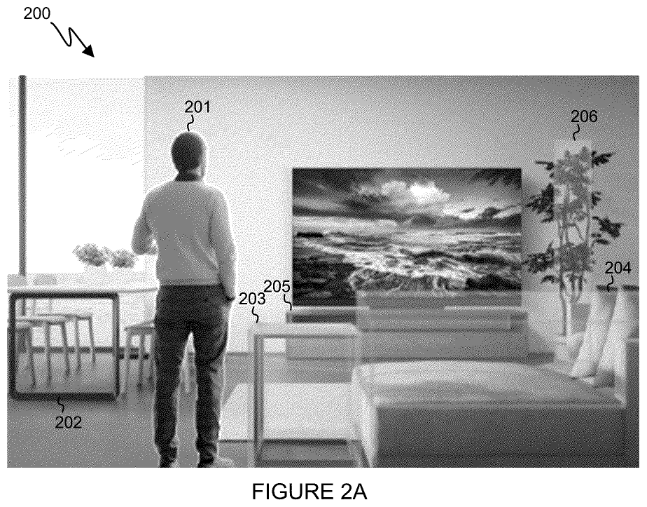

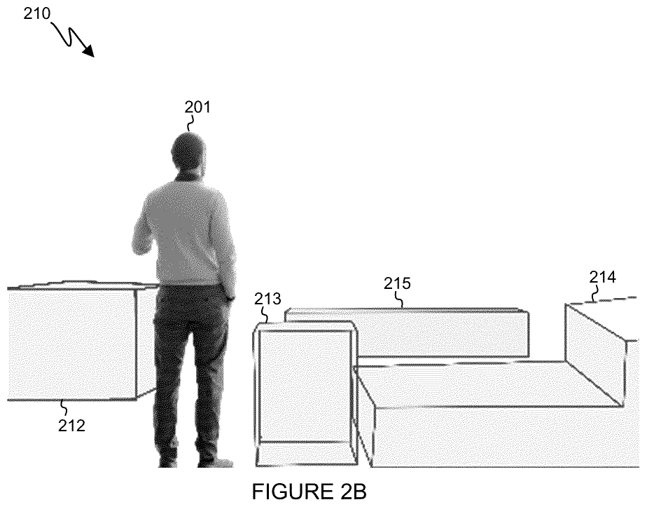

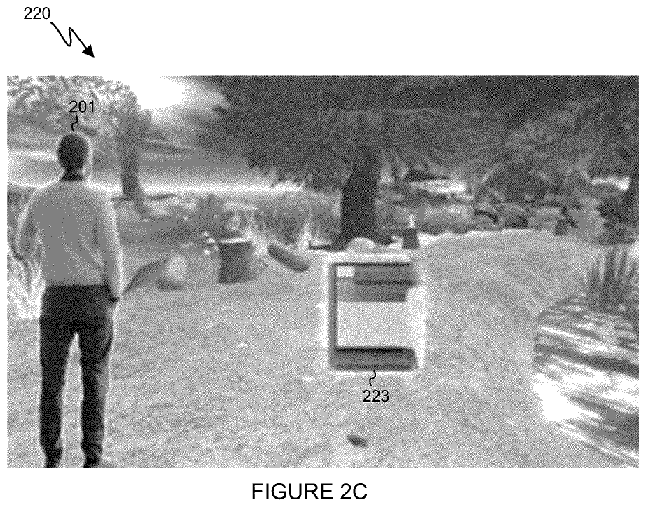

FIGS. 2A through 2C illustrate, using images representing a real-world environment for an immersive headset user, an example provision of a passthrough view of the surrounding real-world environment in accordance with this disclosure. For case of explanation, this is described with respect to the electronic device 101 described above. As noted above, the techniques described here for providing a passthrough view of a surrounding real-world environment for an immersive headset user can involve an XR system (i) understanding the real-world space surrounding the user (such as through object registration), (ii) tracking one or more spatial volumes that represent one or more obstacle positions/rotations in the real-world space, and (iii) presenting the one or more obstacles in a visible manner for user safety.

FIG. 2A illustrates a real-world environment 200 for an immersive headset user 201. Through object registration, the system acquires an understanding of one or more obstacles within the real-world environment 200 within which the user 201 is expected to move. In the example of FIG. 2A, potentially-relevant obstacles include a dining set 202, an end table 203, a chair 204, a television stand 205, and a decorative plant 206.

FIG. 2B illustrates a representation 210 of relevant obstacles (such as those with which the user 201 is most likely to collide) for the real-world environment 200. In this example, the representation 210 includes a wire frame 212 for the spatial volume of the dining set 202, a wire frame 213 for the spatial volume of the end table 203, a wire frame 214 for the spatial volume of the chair 204, and a wire frame 215 for the spatial volume of the television stand 205. Based on the representation 210, the system can track the spatial volumes for the wire frames 212-215 relative to the user 201.

FIG. 2C illustrates a virtual environment 220 with passthrough presentation of an obstacle during XR immersion in a safety mode. Based on the wire frames 212-215 and the relative position of the user 201, the virtual environment 220 includes a passthrough cutout display 223 corresponding to the end table 203. Various forms of the passthrough cutout display may be presented depending on the chosen mode as described in further detail below.

Although FIGS. 2A through 2C illustrate, using images representing a real-world environment for an immersive headset user, one example of a provision of a passthrough view of the surrounding real-world environment, various changes may be made to FIGS. 2A through 2C. For example, the specific user space and the specific objects within the user space are examples only and can easily vary depending on the circumstances.

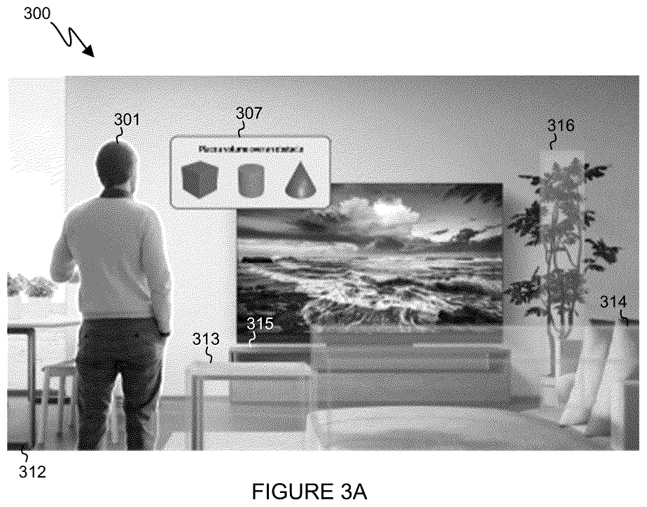

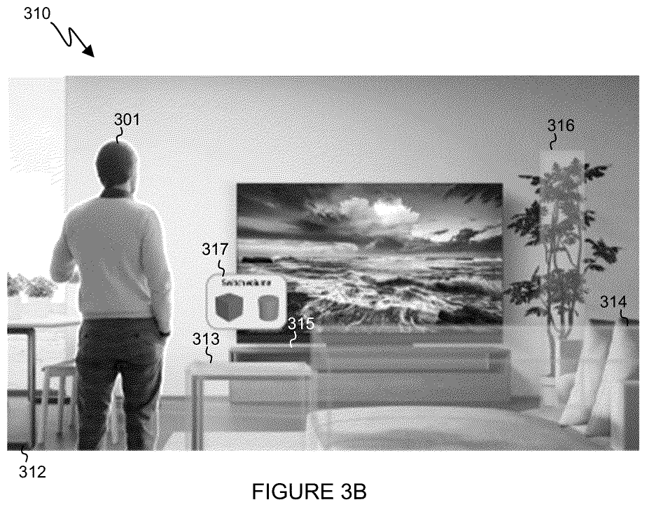

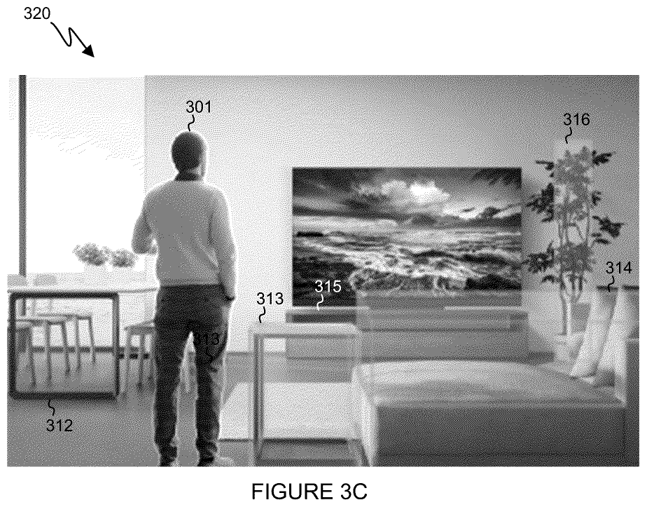

FIGS. 3A through 3C illustrate, using images representing a real-world environment for an immersive headset user, an example object registration for provision of a passthrough view of the surrounding real-world environment in accordance with this disclosure. For case of explanation, this is described with respect to the electronic device 101 described above. Object registration may generally involve identification of obstacles/objects of which the user should be aware (such as while in full VR) through customized passthrough cutouts. In some embodiments, in order to mitigate risks from the system not recognizing obstacles within a user's space, one of three different approaches may be employed.

FIG. 3A illustrates a first approach for object registration in which an immersive system merely displays an image 300 of a real-world environment within which an immersive headset is being used. An image or representation of a user 301 may or may not be displayed in the image 300. In this example, the image 300 includes a palette user interface (UI) 307 of different volume shapes. The user can select a volume from the palette UI 307 and manually place the selected volume over at least one object. Once placed, the user may reposition, scale, or rotate the selected volume to best fit the real-world object(s). In this manner, a wire frame 312 for the spatial volume of a dining set, a wire frame for the spatial volume 313 of an end table, a wire frame for the spatial volume 314 of a chair, a wire frame for the spatial volume 315 of a television stand, and a wire frame for the spatial volume 316 of a decorative plant may be identified. In this approach, in order to place spatial volumes around real-world obstacles, a user can have the ability to select different 3D primitives and place, rotate, and scale the primitives to best fit the obstacles. In this approach, no computer vision-based object recognition may be needed.

In order to place spatial volumes around real-world obstacles, the user can select different 3D primitives from the palette UI 307 and place, rotate, and scale the primitive to best fit the obstacle. When placing volumes, the user is presented with a menu (the palette UI 307) that shows multiple possible shapes, such as a rectangular prism, a column, a cone, a sphere, or a hemisphere. In some cases, the user may tap a selected shape to have that shape appear on the “ground” in the image 300 in the direction in which the user is looking. The user may also pinch and drag the selected volume onto the floorspace preferred. While the selected volume may initially be positioned to lie on the floor, the user may modify the shape using certain tools. In some cases, the shape is translucent with highlighted edges so that the user may see the obstacle being encased while also having a clear view of the volume occupied by the shape. The shape can also be deleted or duplicated after being placed.

FIG. 3B illustrates a second approach for object registration in which an immersive system suggests one or more spatial volumes for semi-recognized objects in a real-world environment within which an immersive headset is being used. In this example, the immersive system displays an image 310 of a real-world environment, which may or may not include an image or representation of the user 301. The immersive system performs some vision-based object recognition, popping up a palette UI 317 over a semi-recognized object with suggestions in the palette UI 317 for a volume corresponding to the semi-recognized object. In the example of FIG. 3B, the semi-recognized object is an end table, and the palette UI 317 contains a generally cubic shape and a generally cylindrical shape (but not a cone shape as in palette UI 307), and the user may select a volume from the palette UI 317. Again, the user may reposition, scale, or rotate the volume to fit to the semi-recognized object once a volume is selected. Here, the user can help determine the volume that best fits each semi-recognized object.

FIG. 3C illustrates a third approach for object registration in which an immersive system automatically recognized one or more spatial volumes for one or more objects in the real-world environment within which an immersive headset is being used. Here, the immersive system can automatically detect one or more objects and reliably place one or more spatial volumes that enclose the object(s). This approach can involve the use of stable object recognition, and no palette UI may be needed.

Although FIGS. 3A through 3C illustrate, using images representing a real-world environment for an immersive headset user, one example of an object registration for provision of a passthrough view of the surrounding real-world environment, various changes may be made to FIGS. 3A through 3C. For example, the specific user space and the specific objects within the user space are examples only and can easily vary depending on the circumstances. Also, any other suitable techniques may be used to perform object registration.

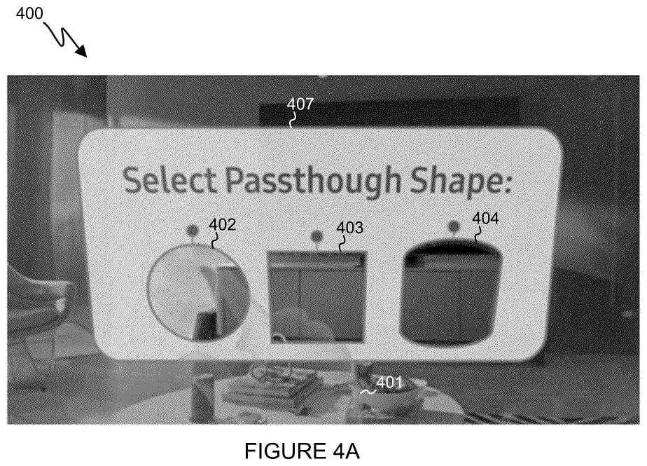

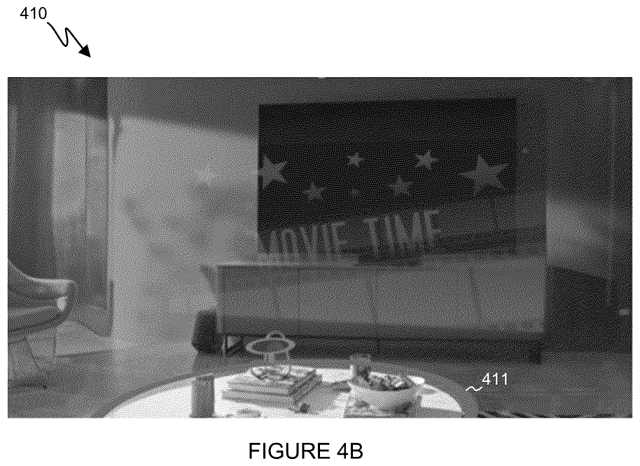

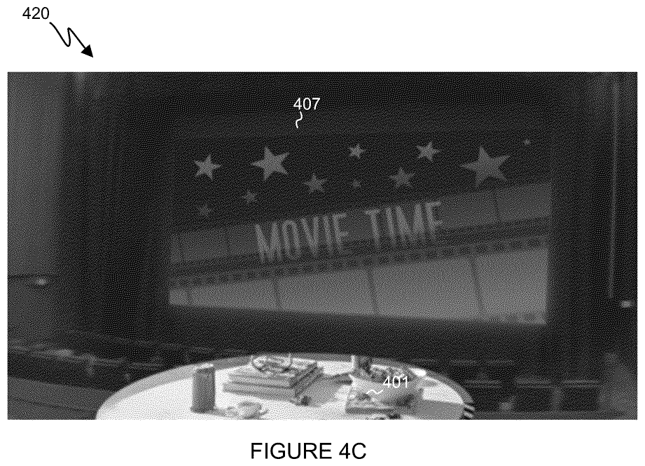

FIGS. 4A through 4C illustrate, using images representing an immersive reality overlay on a real-world environment, an example manual placement of a volume on an object in a real-world environment in accordance with this disclosure. For ease of explanation, this is described with respect to the electronic device 101 described above.

FIG. 4A depicts an immersive display 400 enabling a user to manually place a volume over an object in a real-world environment in which an immersive headset is being used. The immersive display 400 includes a palette UI 407 of passthrough shapes. The immersive display 400 also includes a cursor 401, shown as a phantom or semi-transparent hand in the example illustrated. The user moves the cursor 401 to select one of the passthrough shapes in the palette UI 407, which include a sphere 402, a rectangular prism 403, and a column or cylinder 404 in this example. In FIG. 4A, the user is selecting the sphere 402. The user can place the selected shape on at least one object in the real-world environment.

FIG. 4B depicts an immersive display 410 illustrating placement of the selected shape on a coffee table, with the shape being moved and sized to encompass the coffee table as shown by highlighting ring 411. FIG. 4C depicts an immersive display 420 that illustrates the coffee table being shown as a passthrough object within an immersive environment (a movie theater in the example depicted) so that the user can easily find and reach drinks and snacks on the coffee table during an immersive video watching experience.

Although FIGS. 4A through 4C illustrate, using images representing an immersive reality overlay on a real-world environment, one example of a manual placement of a volume on an object in a real-world environment, various changes may be made to FIGS. 4A through 4C. For example, the specific user space and the specific objects within the user space are examples only and can easily vary depending on the circumstances.

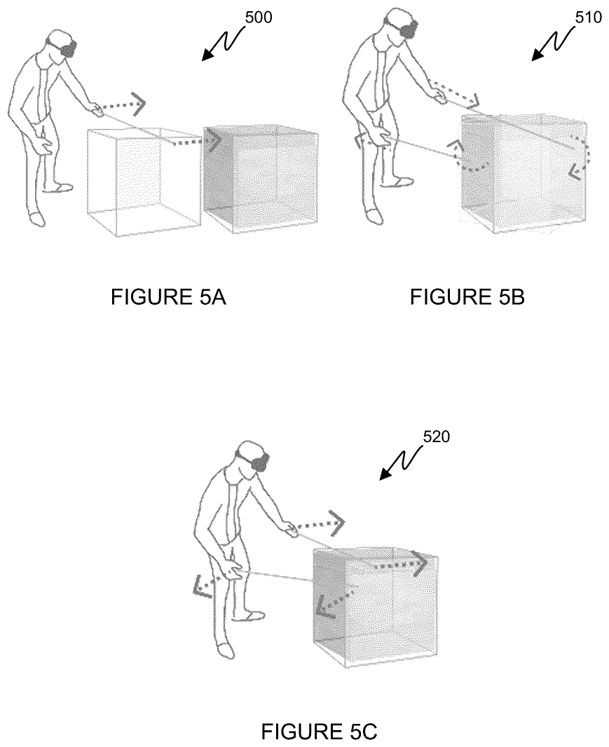

FIGS. 5A through 5C illustrate an example shape modification during manual placement of a spatial volume (FIG. 3A) and an example modification of a suggested spatial volume (FIG. 3B) overlaid on a real-world object in accordance with this disclosure. For ease of explanation, this is described with respect to the electronic device 101 described above.

Once a shape is defined in a user's XR space, the user can use one or both hands (or controllers) to modify the shape. FIG. 5A illustrates an example of modifying a position of a shape in the user's XR space. As illustrated by a diagram 500, the user may use one hand directly on an object (or use a cursor using a hand ray or controller ray) to grab the object and drag the object to its appropriate space. The shape may retain the same orientation relative to the user's XR space as the shape moves.

FIG. 5B illustrates an example of a rotation of a shape in the user's XR space. As illustrated by a diagram 510, the user may use two hands (or two controllers) to rotate the shape. In some cases, the shape can rotate on axes defined by the position midpoint of the two touch points and the angle defined by the direction in which the two grab points are moving. As a particular example, the axes may default to rotation along the y axis until the direction of the axes breaks 30° or other amount from the y axis.

FIG. 5C illustrates an example of scaling of a shape in the user's XR space. As illustrated by a diagram 520, the user may use two hands (or two controllers) to scale the shape uniformly, such as by dragging touchpoints in opposite directions. In some cases, during scaling, the shape may maintain the lowest position in contact with the floor of the user's XR space, so the shape may scale upwards and outwards. For certain shapes, there may be a scale axis tool that allows the shape to be scaled (stretched or compressed) along only one axis. The tool may be shown as a control on one face of the shape that can be pulled in one direction, which scales the shape along that axis.

Although FIGS. 5A through 5C illustrate examples of a shape modification during manual placement of a spatial volume (FIG. 3A) and of a suggested spatial volume (FIG. 3B) overlaid on a real-world object, various changes may be made to FIGS. 5A through 5C. For example, the specific user space and the specific objects within the user space are examples only and can easily vary depending on the circumstances. Also, the specific modifications shown in FIGS. 5A through 5C are examples only and can easily vary.

Referring back to FIG. 3B, instead of manually placing volumes, an immersive headset's sensor(s) (alone or with machine learning) can be utilized to suggest a shape of each of one or more obstacles. In some cases, suggestion of a shape can involve an understanding of the position of each obstacle in combination with rudimentary shape recognition. Shape suggestion allows the immersive headset to present recommended shapes at obstacle locations. As a particular example, an immersive headset may utilize red/green/blue (RGB) and depth sensors to understand the user's real-world environment up to the point of understanding where obstacles are located. Depending on the implementation, the immersive headset may understand the footprint of the obstacles but not necessarily the volumes of the obstacles.

Based on an obstacle footprint, footprint coordinate data may be processed, such as by a machine learning algorithm or a shape-fitting algorithm, to create a set of possible 3D primitives to present to the user. In some cases, the set of shapes may be presented in a narrowed-down shape palette menu (such as the palette UI 317). In some embodiments, the menu position can be shown at the center point of the obstacle footprint and at the height of the highest detected obstacle point. With that display, the user may select and modify the shape to best fit the obstacle using the tools described in connection with FIGS. 5A through 5C.

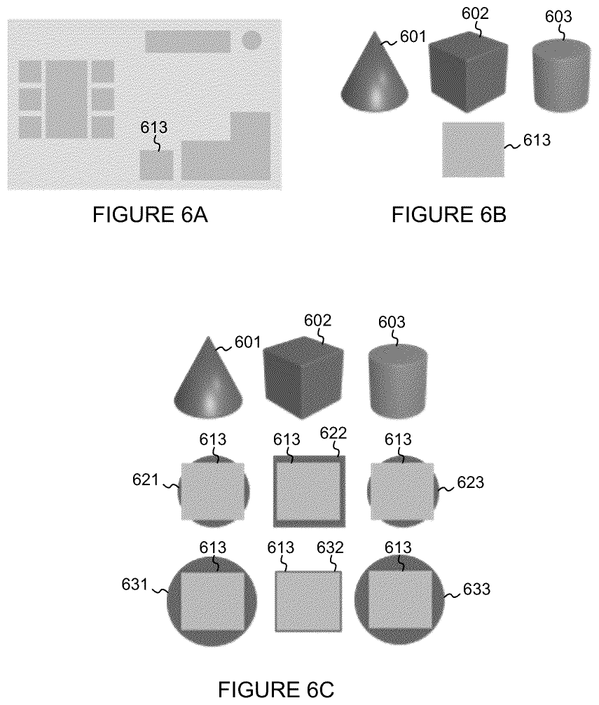

FIGS. 6A through 6C illustrate an example shape recognition for a real-world object in accordance with this disclosure. For case of explanation, this is described with respect to the electronic device 101 described above. FIG. 6A illustrates footprint coordinates corresponding to those determined by scanning the room depicted in FIGS. 3A through 3C. The footprints include footprint coordinates 613 corresponding to a footprint for the wire frame corresponding to the spatial volume 313 of the end table.

FIG. 6B illustrates the same footprint coordinates 613 together with three shape primitives 601-603 that may be considered for matching. Various approaches may be employed for comparing the shape primitives 601-603 to the footprint coordinates 613. For example, one approach may use machine learning in which, for the footprint of each obstacle, machine learning can judge the footprint against the likelihood of each shape primitives 601-603 matching the footprint. As an example, the footprint coordinates can be sent to a machine learning algorithm that has been trained to judge coordinates and suggest certain shapes.

Another approach may employ a space-fitting algorithm that fits the shape footprint around the obstacle footprint and presents the shapes that best wrap around the obstacle. For example, as illustrated in FIG. 6C, the footprint coordinates 613 may be sent to a space-fitting algorithm that superimposes a top-down shape for each shape primitive 601-603 onto the footprint coordinates 613. Enclosure of the footprint by the shape may be ensured by enlarging and then shrinking/rotating the shape primitive 601-603 until all footprint coordinates 613 fit within the shape primitive 601-603.

As shown in FIG. 6C, a nominal shape footprint 621 for the shape primitive 601 does not encompass all footprint coordinated 613. An enlarged shape footprint 631 for the shape primitive 601 can therefore be used to fully encompass the footprint coordinates 613. Similarly, a nominal shape footprint 623 for the shape primitive 603 does not encompass all footprint coordinates 613, and an enlarged shape footprint 633 for the shape primitive 603 can be used. By contrast, a nominal shape footprint 622 for the shape primitive 602 is more than sufficient to fully encompass the footprint coordinates 613, and a compressed shape footprint 633 for the shape primitive 603 can enclose the footprint coordinates 613.

After scaling of the shape primitive 601-603, the percentage of how much (such as what percentage) of the footprint coordinates 613 take up space within the scaled and/or rotated shape footprint for one of the shape primitives 601-603 may be measured. Based on the determined percentage, the highest percentage (or two or three highest percentages) covering shape primitives 601-603 can be used to form the set suggested to the user.

Although FIGS. 6A through 6C illustrate one example of shape recognition for a real-world object, various changes may be made to FIGS. 6A through 6C. For example, the specific user space and the specific objects within the user space are examples only and can easily vary depending on the circumstances. Also, any other suitable techniques may be used to perform shape recognition.

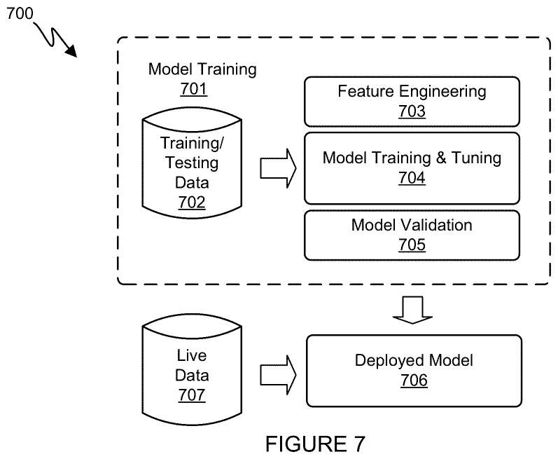

FIG. 7 illustrates example training and deployment of a machine learning model for shape recognition of a real-world object in accordance with this disclosure. For case of explanation, this is described with respect to the electronic device 101 described above. As described above, rather than relying on user input to best fit 3D shapes of real-world obstacles, a machine learning (ML) model may be trained, such as based on depth and image data, to use object segmentation and shape recognition machine learning to automatically place best-fitting spatial volumes over obstacles.

As shown in FIG. 7, a process 700 for training and deployment of a machine learning model for shape recognition of real-world object(s) includes model training 701. In some embodiments, during model training 701, RGB or other images and associated depths for real-world environments with corresponding identifications of obstacles and best-fitting shape primitives can be provided as training data 702. The images, obstacles, and shape primitives can be used in feature engineering 703, which selects, manipulates, and transforms that raw data into features that can be used by a predictive model 704. In some cases, supervised learning statistical modeling may be used. Also, in some cases, the predictive model 704 may be used to estimate point clouds of obstacles and shape-fit spatial volumes to the point clouds. The position of where shapes should be located and how to best fit the shapes to conform to obstacles' point clouds may be found through positioning, rotation, and scaling of the shape primitives as discussed above. The predictive model 704 may also be fine-tuned to more accurately choose a best-fit shape for and to place appropriate spatial volumes over identified obstacles.

Model validation 705 evaluates the trained predictive model 704 for accuracy of inferences, such as by using testing data sets within the training data 702. Once the predictive model 704 is appropriately accurate, the predictive model 704 is deployed as a model 706 for operation on live data 707. Thus, during inferencing involving the live data 707, the model 706 can suggest shapes, shape positions, rotations, and scales for placement of spatial volumes over obstacles in processed scenes for real-world environments. At this point, a user may simply confirm predicted spatial volumes or choose to modify one or more spatial volumes.

Although FIG. 7 illustrates one example of training and deployment of a machine learning model for shape recognition of a real-world object, various changes may be made to FIG. 7. For example, any suitable process may be used to train a machine learning model for shape recognition.

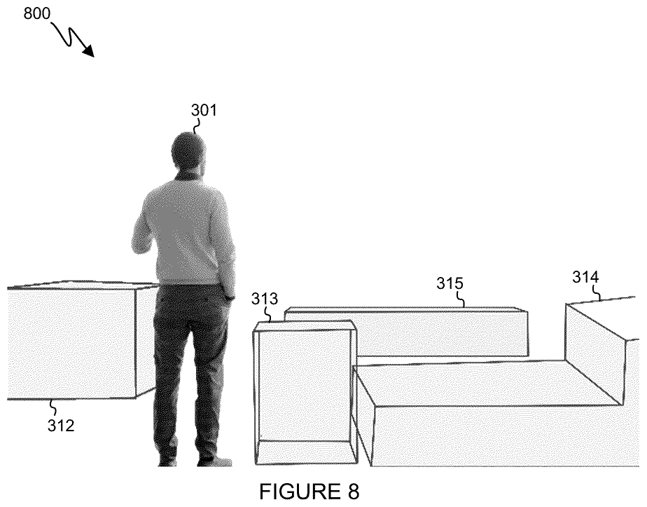

FIG. 8 illustrates example spatial volumes for provision of a passthrough view of objects in a real-world environment following object registration in accordance with this disclosure. For case of explanation, this is described with respect to the electronic device 101 described above. In this example, a set 800 of spatial volumes corresponds to the real-world environment depicted in FIGS. 3A through 3C. Note that the set 800 of spatial volumes may be determined regardless of whether object registration is determined manually as described in connection with FIG. 3A, is based on system suggestions as described in connection with FIG. 3B, or is automatically performed as described in connection with FIG. 3C.

In this example, the set 800 includes the wire frame 312 for the spatial volume of the dining set, the wire frame for the spatial volume 313 of the end table, the wire frame for the spatial volume 314 of the chair, and the wire frame for the spatial volume 315 of the television stand as obstacles to movement of the user 301 within the real-world environment within which the immersive headset is being used. Following object registration, spatial volume tracking can be performed based on the set 800 of spatial volumes. For example, after obstacles are represented by the spatial volumes, spatial volume poses can be confirmed and stored. As the user 301 moves around the real-world environment, the system can ensure that the spatial volume poses remain relative to the user 301 and the user's space. In some cases, basic distance checks, such as those determined using binary space partitioning (BSP) or a k-d tree, can be performed to check whether the spatial volumes of the wire frames 312-315 are near the user 301. For spatial volumes within a certain distance, a check from the head, hands, and/or other part(s) of the user 301 to the nearest point on the spatial volume may be performed. If the distance is within a prescribed threshold, immersion safety strategies of the type described below may be utilized.

Note that the user 301 may or may not want to show all obstacles using an immersion safety strategy. Accordingly, different approaches allowing the user 301 to activate/deactivate spatial volumes that are tracked may be supported. Users may want to activate certain spatial volumes depending on the immersive experience desired. In some cases, for example, the user 301 may enter a full motion experience that can utilize the whole room, and all spatial volumes within the boundaries can be active. In other cases, the user 301 may just want a stationary sitting experience, like watching a movie, and may want the spatial volumes for a couch and a coffee table to be active. Furthermore, users may wish to access spatial volume activation tools at different times, such as after the object registration process, before entering an immersive experience, or from a system menu while in the immersive experience. Accordingly, although a user may deactivate a spatial volume, the spatial volume may remain in order to allow spatial volumes to be activated at a later time.

Although FIG. 8 illustrates examples of spatial volumes for provision of a passthrough view of objects in a real-world environment following object registration, various changes may be made to FIG. 8. For example, the specific spatial volumes and the specific objects are examples only and can easily vary depending on the circumstances.

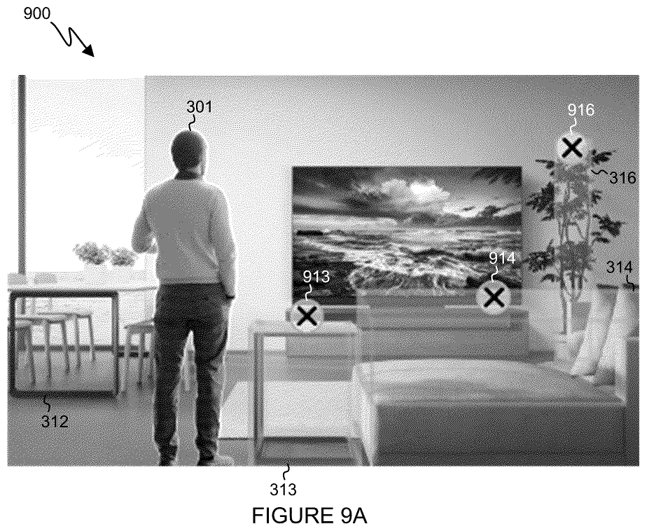

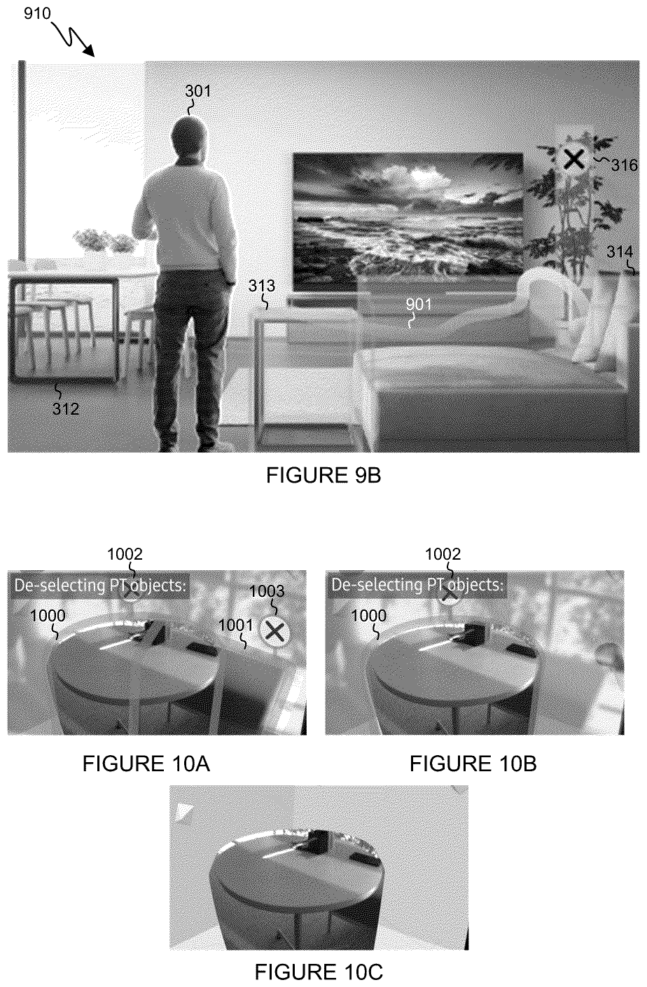

FIGS. 9A and 9B illustrate, using images representing a real-world environment for an immersive headset user, example spatial volume activations for provision of a passthrough view of the surrounding real-world environment in accordance with this disclosure. For ease of explanation, this is described with respect to the electronic device 101 described above. Note that an image or representation of the user 301 may or may not be displayed here.

In order to aid the user 301 in selecting which volumes should be active, various tools may be used. For example, in a display 900 shown in FIG. 9A, an X or check mark button is displayed above/on top of each spatial volume. As shown in FIG. 9A, an activation toggle button 913 is provided for spatial volume 313, an activation toggle button 914 is provided for spatial volume 314, and an activation toggle button 916 is provided for spatial volume 316. The user 301 may toggle each button to activate/deactivate the corresponding volume. In some cases, active volumes may appear with slightly opaque faces and fairly opaque edges, while deactivated volumes may have faces that appear more translucent and desaturated with less bright edges.

As another example, in a display 910 shown in FIG. 9B, a quick selection tool is enabled. By pinching and dragging his or her hand or a controller cursor over multiple volumes (along path 901), the user 301 may activate/deactivate multiple spatial volumes. Thus, for instance, if the first volume pinched was inactive, the first volume can be activated, and all subsequent volumes that were inactive and dragged over can also be activated. On the other hand, if the first volume pinched was active, that volume can be deactivated, along with other subsequent volumes that are dragged over until the pinch is released.

Although FIGS. 9A and 9B illustrate, using images representing a real-world environment for an immersive headset user, examples of spatial volume activations for provision of a passthrough view of the surrounding real-world environment, various changes may be made to FIGS. 9A and 9B. For example, any other suitable techniques may be used to activate or deactivate spatial volumes.

FIGS. 10A through 10C illustrate an example toggling spatial volume activation for a passthrough view of objects in the surrounding real-world environment in accordance with this disclosure. For case of explanation, this is described with respect to the electronic device 101 described above.

As shown in FIG. 10A, a table and an ottoman determined to be obstacles within the space within which an immersive headset is being used are defined by respective spatial volumes 1000 and 1001, which outline the obstacles. Corresponding toggle buttons 1002 and 1003 can be displayed above the spatial volumes 1000 and 1001. When the user wants to deselect a specific object like the ottoman, the user may use his or her hand(s) or controller(s) to select the toggle button 1003. As shown in FIG. 10B, the spatial volume 1001 has been deselected. As shown in FIG. 10C, when the user enters or returns to the immersive environment, only the table corresponding to the spatial volume 1000 may be seen and tracked by the chosen immersion safety strategy.

Although FIGS. 10A through 10C illustrate one example of toggling spatial volume activation for a passthrough view of objects in the surrounding real-world environment, various changes may be made to FIGS. 10A through 10C. For example, the specific user space and the specific objects within the user space are examples only and can easily vary depending on the circumstances. Also, any other suitable techniques may be used to toggle spatial volumes.

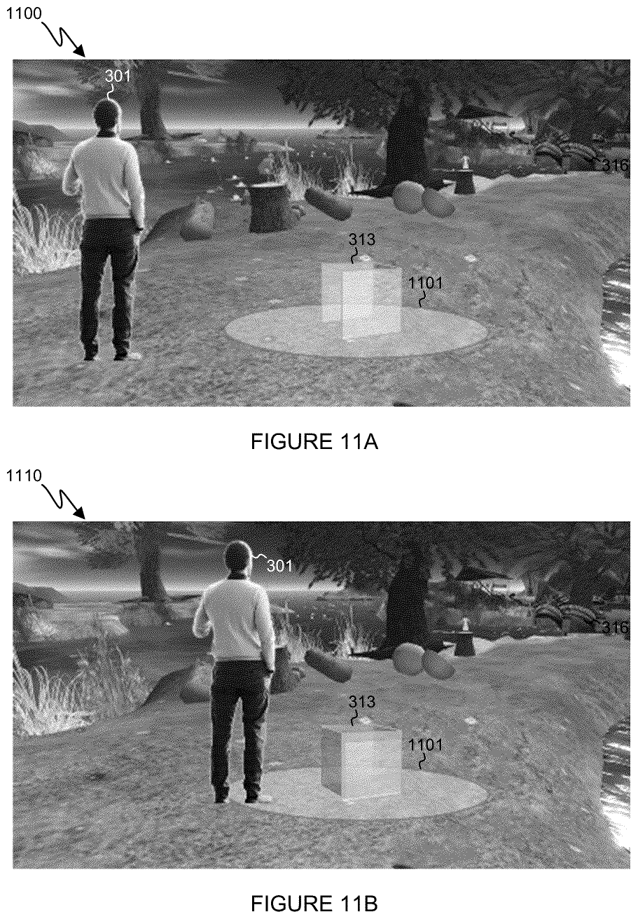

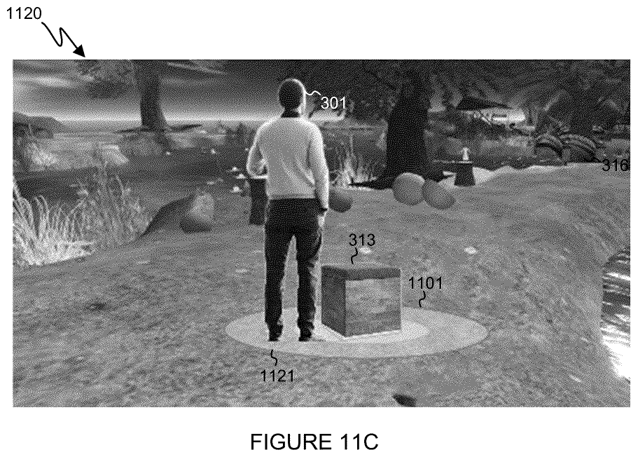

FIGS. 11A through 11C illustrate, using images representing an immersive environment, an example tracking of real-world objects for provision of a passthrough view in accordance with this disclosure. For ease of explanation, this is described with respect to the electronic device 101 described above. Note that an image or representation of the user 301 may or may not be displayed here.

One or more immersion safety implementations can be utilized and may be based on activated spatial volume tracking and passthrough cutouts to make real-world environment obstacles visible in real-time to a user. For example, while the user 301 is in an immersive experience represented by a display 1100, a spatial volume 313 (rendered by the cube) can be tracked relative to the user 301. In some cases, the immersion safety mode includes a prescribed distance (indicated by an ellipse 1101 on the “ground”). As long as the user 301 is not within the prescribed distance, the spatial volume 313 is invisible (not shown as in FIG. 11A) so the user 301 may enjoy the immersive experience fully. Once the user 301 enters the distance, the spatial volume 313 is wrapped in a passthrough material as shown in FIG. 11B. The passthrough material can be used to render an image from a passthrough or other camera on top of the spatial volume. A “moderate” immersion safety strategy may additionally implement an edge filter onto the object, while other strategies may not implement a filter and show the passthrough image unadulterated.

In some cases, the passthrough material's opacity may be proportional to the distance of the user 301 from the spatial object. For example, the immersive experience display may make the passthrough image less visible when the user 301 is farther from the object. The immersive experience display may make the passthrough image more visible when the user 301 is closer to the object. There may also be an inside distance (indicated by an ellipse 1121) where the spatial volume material is fully visible relative to the immersive environment display (while still utilizing a filter if applicable). Once the user is close enough (such as inside the ellipse 1121), the obstacle may be fully rendered as shown in FIG. 11C, providing full awareness to the user 301.

Although FIGS. 11A through 11C illustrate, using images representing an immersive environment, one example of tracking of real-world objects for provision of a passthrough view, various changes may be made to FIGS. 11A through 11C. For example, the specific user space and the specific objects within the user space are examples only and can easily vary depending on the circumstances. Also, any other suitable distances may be used here. In addition, the ellipses may not be rendered but are provided merely for the purposes of explanation.

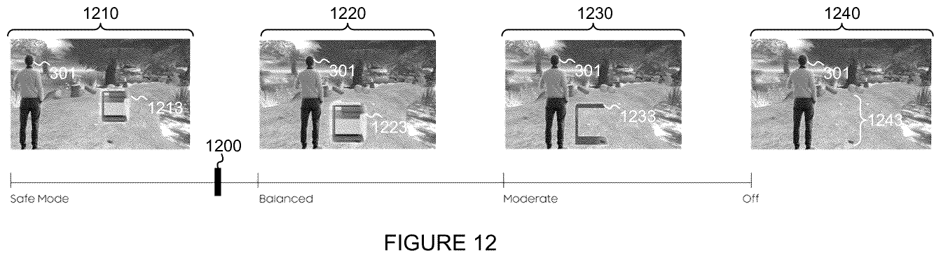

FIG. 12 illustrates example immersion safety modes for a passthrough view of real-world objects in an immersive environment in accordance with this disclosure. For ease of explanation, this is described with respect to the electronic device 101 described above. Note that an image or representation of the user 301 may or may not be displayed here.

Different immersion safety modes may be supported and may allow the user to control a desired balance of immersion and safety. For example, in safer modes, a visibility distance threshold may be larger, and rendering of obstacles can be more prominent and opaque. In more immersive modes, the visibility distance threshold is much closer to the user, and the rendering can be more translucent and minimal. These settings can change along a gradient as illustrated in FIG. 12, which allows the user to fine-tune the operation of the headset. In some cases, the user may switch modes through an immersion safety slider 1200, which could be activated through a system menu or other suitable mechanism.

Four different immersion safety modes are illustrated in the example of FIG. 12. These different immersion safety modes are identified by different images corresponding to different positions of slider 1200. An image 1210 corresponding to a safe mode prioritizes safety over immersion, and a passthrough cutout volume 1213 for a real-world object may be visible from a farther distance than in the remaining settings (ensuring that the user 301 is more aware of the obstacle). An image 1220 corresponding to a balanced mode balances safety and immersion more or less equally, and a passthrough cutout volume 1223 may be visible from a closer distance to the user 301 (such as inside the ellipse 1101 of FIGS. 11A through 11C) but not from farther distances (such as outside the ellipse 1101 of FIGS. 11A through 11C). An image 1230 corresponding to a moderate mode prioritizes immersion over safety, and only object outlines may be rendered in a passthrough cutout volume 1233 to help immerse the user 301 while giving minor awareness of obstacles. An image 1240 for an “off” mode show that the user will not view passthrough cutouts of obstacles in a corresponding passthrough cutout volume 1243.

Although FIG. 12 illustrates examples of immersion safety modes for a passthrough view of real-world objects in an immersive environment, various changes may be made to FIG. 12. For example, the specific immersion safety modes shown here are examples only and can vary depending on the implementation.

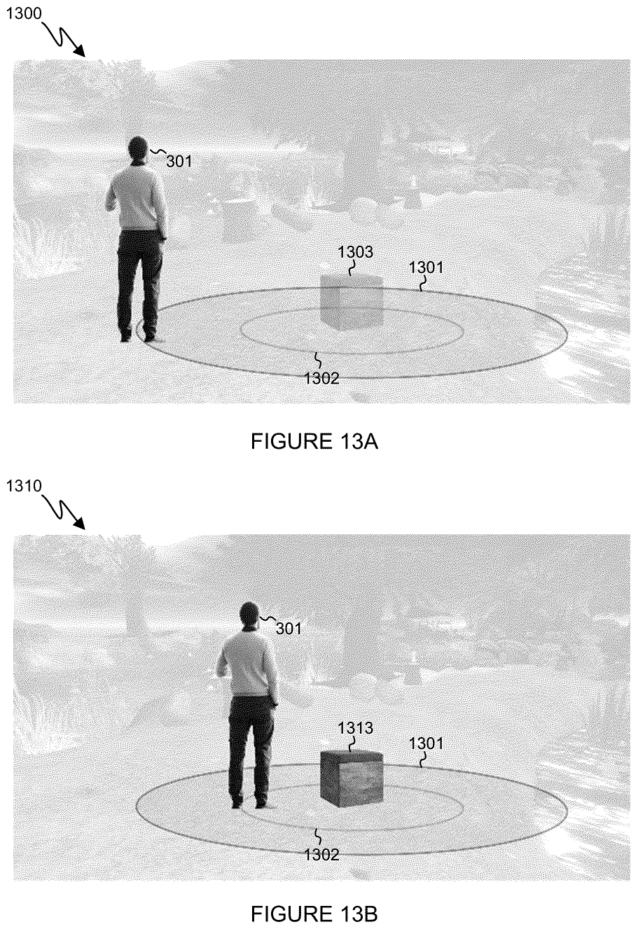

FIGS. 13A and 13B illustrate, using images representing an immersive environment, an example passthrough view of obstacles in the real-world environment surrounding an immersive headset user while in a safe immersion safety mode in accordance with this disclosure. For ease of explanation, this is described with respect to the electronic device 101 described above. Note that an image or representation of the user 301 may or may not be displayed here.

In some embodiments, a safe immersion safety mode can visualize an obstacle starting from a farther distance than other immersion safety modes in order to provide more awareness. For example, in a first display 1300 shown in FIG. 13A, a user 301 is located within a first distance (represented by an ellipse 1301) from an object but outside a second distance (represented by an ellipse 1302). In some cases, the first distance may be approximately 2 meters (m), and the second distance may be approximately 1 m. Also, in some cases, both the first distance and the second distance are larger than in any other immersion safety mode.

A passthrough image 1303 of an obstacle is rendered in the immersive environment image. For example, when the user 301 enters the outer distance check, the passthrough cutout may start to become translucent. As the user's distance comes closer to the obstacle, such as within the second distance (represented by the ellipse 1302), the passthrough material may become more opaque. Throughout the movement, the user 301 may still view the immersive environment completely. Once the user is as close as the second distance, the passthrough spatial volume material 1313 may be fully opaque, at least until the user moves farther from the object represented.

Although FIGS. 13A and 13B illustrate, using images representing an immersive environment, one example of a passthrough view of obstacles in the real-world environment surrounding an immersive headset user while in a safe immersion safety mode, various changes may be made to FIGS. 13A and 13B. For example, the specific user space and the specific objects within the user space are examples only and can easily vary depending on the circumstances. Also, any other suitable distances may be used here. In addition, the ellipses may not be rendered but are provided merely for the purposes of explanation.

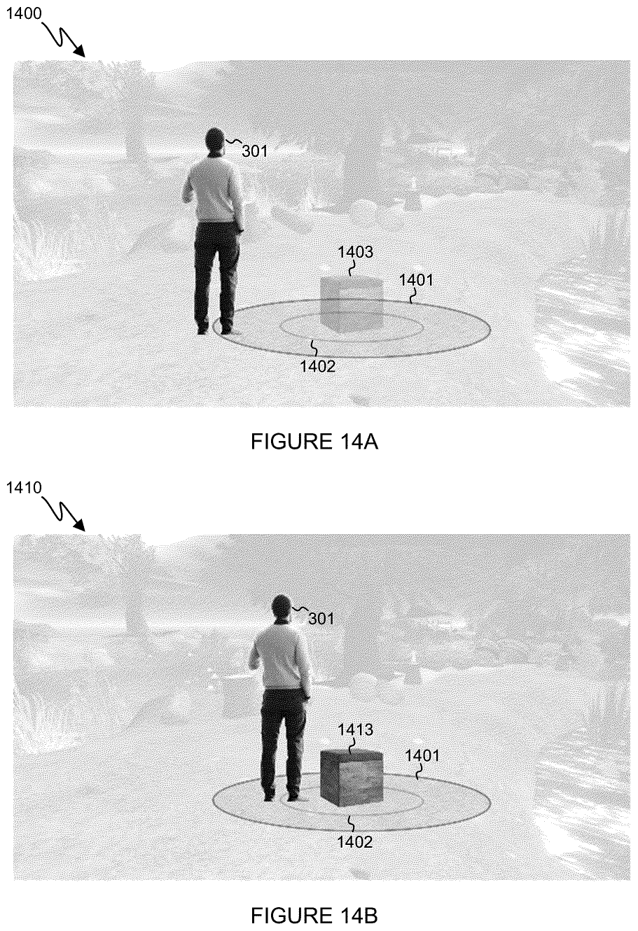

FIGS. 14A and 14B illustrate, using images representing an immersive environment, an example passthrough view of obstacles in the real-world environment surrounding an immersive headset user while in a balanced immersion safety mode in accordance with this disclosure. For case of explanation, this is described with respect to the electronic device 101 described above. Note that an image or representation of the user 301 may or may not be displayed here.

In some embodiments, a balanced immersion safety mode can visualize the obstacle starting from relatively close distance, such as a distance of about 1 stride (approximately 1 m), to support balanced awareness and immersion. For example, similar to the safe immersion safety mode, when the user 301 enters the first (outer) distance check area (represented by an ellipse 1401), a passthrough cutout 1403 may begin to become translucent. As the user's distance comes closer to a second (inner) distance check area (represented by an ellipse 1402), the passthrough material may become more opaque. Once the user 301 is as close as the inner distance check (such as around 0.5 m), the passthrough spatial volume material 1413 can be fully opaque, at least until the user moves farther from the obstacle. In particular embodiments, the only difference between the safe immersion safety mode and the balanced immersion safety mode may be that the distance checks are at different (such as smaller) distances.

Although FIGS. 14A and 14B illustrate, using images representing an immersive environment, one example of a passthrough view of obstacles in the real-world environment surrounding an immersive headset user while in a balanced immersion safety mode, various changes may be made to FIGS. 14A and 14B. For example, the specific user space and the specific objects within the user space are examples only and can easily vary depending on the circumstances. Also, any other suitable distances may be used here. In addition, the ellipses may not be rendered but are provided merely for the purposes of explanation.

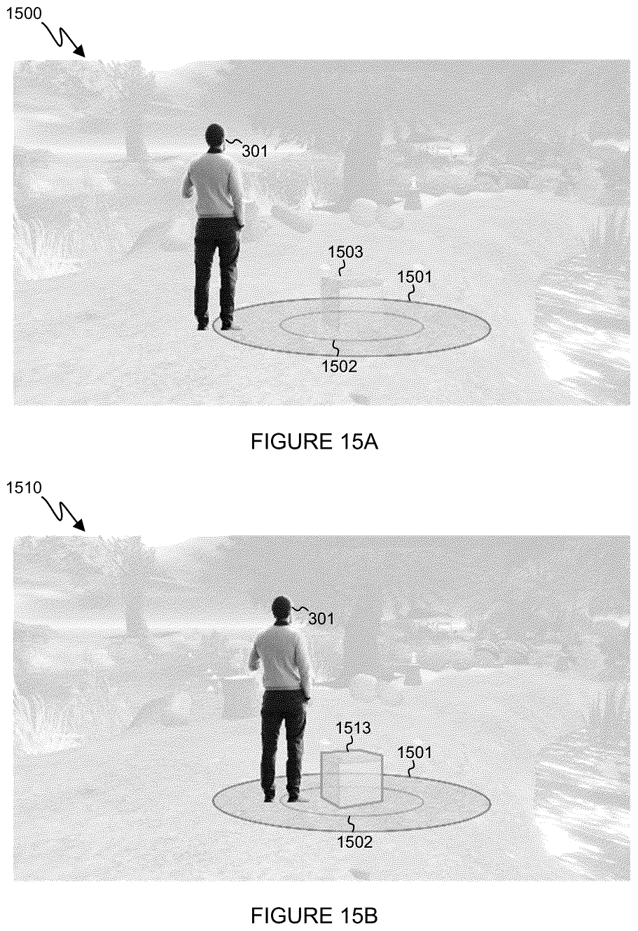

FIGS. 15A and 15B illustrate, using images representing an immersive environment, an example passthrough view of obstacles in the real-world environment surrounding an immersive headset user while in a moderate immersion safety mode in accordance with this disclosure. For case of explanation, this is described with respect to the electronic device 101 described above. Note that an image or representation of the user 301 may or may not be displayed here.

In some embodiments, a moderate immersion safety mode may have similar distance checks from the balanced immersion safety mode but may add a filter to promote immersion while still providing moderate obstacle awareness. For example, when the user 301 enters the first (outer) distance check area (represented by an ellipse 1501), the filter for the spatial volume of the obstacle may use an outline shader to outline the spatial volume at a low opacity value (such as about 30-35%). Also, a passthrough cutout material image 1503 may be at a lower opacity (such as about 15-25%). The passthrough cutout image 1503 may be run through an additional filter that desaturates color and increases edges to promote edge awareness of the obstacle. Once the user is as close as the second (inner) distance check area (represented by an ellipse 1502), the outline shader may become more opaque (such as about 65%). The passthrough cutout material may still be at a low opacity (such as about 45%), and the filter may continue to desaturate color and with edges with some opacity. In some cases, the outline color, opacity, and filter strengths can be modified by the user 301.

Although FIGS. 15A and 15B illustrate, using images representing an immersive environment, one example of a passthrough view of obstacles in the real-world environment surrounding an immersive headset user while in a moderate immersion safety mode, various changes may be made to FIGS. 15A and 15B. For example, the specific user space and the specific objects within the user space are examples only and can easily vary depending on the circumstances. Also, any other suitable distances may be used here. In addition, the ellipses may not be rendered but are provided merely for the purposes of explanation.

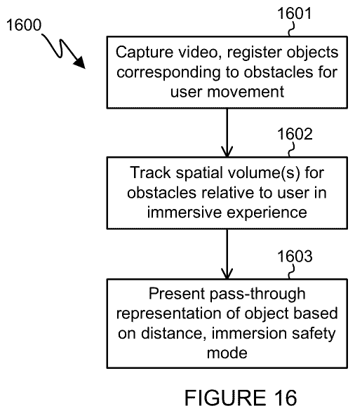

FIG. 16 illustrates an example process 1600 for providing a passthrough view of obstacles in the surrounding real-world environment for an immersive headset user in accordance with this disclosure. For case of explanation, the process 1600 is described as involving the use of the electronic device 101 in the network configuration 100 of FIG. 1. However, the process 1600 may be used with any other suitable electronic device(s), such as the server 106, and in any other suitable system(s).

As shown in FIG. 16, video of a real-world environment within which an immersive headset is being used is captured, and one or more objects corresponding to one or more obstacles are registered to user movement within that real-world environment (operation 1601). Depending on the implementation, object registration may be performed manually by the user (as described in connection with FIGS. 3A and 4A-4C), performed based on one or more suggested shapes and user selection and modification (as described in connection with FIGS. 3B and 5A-5C), or performed automatically (as described in connection with FIGS. 3C and 6A-6C). In each approach, controls for modification of the spatial volumes corresponding to objects that may become obstacles to user movement may be provided.

One or more spatial volumes for one or more registered objects are tracked within the real-world environment relative to the user (operation 1602). As part of tracking the registered object(s), one or more user controls for toggling spatial volume activation may be provided. One or more passthrough representations of one or more registered objects are provided based on the activated spatial volume(s) within one or more immersive experience displays (operation 1603). The distance between an object and the user when the passthrough representation is presented may vary depending upon the active mode of two or more immersion safety modes. The particular passthrough representation presented within the immersive experience display(s) may likewise vary depending upon the active mode of the two or more immersion safety modes. One or more user controls for selecting distance(s), passthrough representation(s), or both for each of the two or more immersion safety modes may be enabled.

Although FIG. 16 illustrates one example of a process 1600 for providing a passthrough view of obstacles in the surrounding real-world environment for an immersive headset user, various changes may be made to FIG. 16. For example, while shown as a series of steps, various steps in FIG. 16 could overlap, occur in parallel, occur in a different order, or occur any number of times (including zero times).

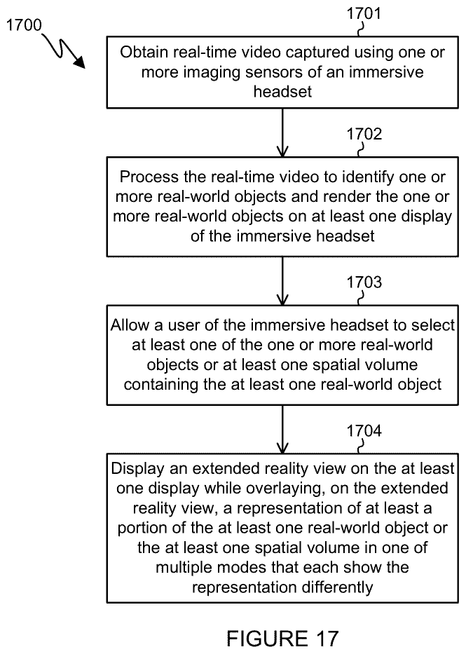

FIG. 17 illustrates another example process 1700 for providing a passthrough view of obstacles in the surrounding real-world environment for an immersive headset user in accordance with this disclosure. For case of explanation, the process 1700 is described as involving the use of the electronic device 101 in the network configuration 100 of FIG. 1. However, the process 1700 may be used with any other suitable electronic device(s), such as the server 106, and in any other suitable system(s).

As shown in FIG. 17, real-time video is captured using one or more imaging sensors of an immersive headset (operation 1701). In some cases, distance sensor data corresponding to the real-time video may be concurrently captured. The real-time video is processed to identify one or more real-world objects and render the one or more real-world objects on at least one display of the immersive headset (operation 1702). In some cases, the distance sensor information may be employed as part of determining spatial volumes for the one or more real-world objects, such as when used as part of suggesting shape primitives to a user or automatically determining a shape of the real-world objects.

A user of the immersive headset is allowed to select at least one of the one or more real-world objects or at least one spatial volume containing the at least one real-world object (operation 1703). In some cases, the selection of the at least one of the one or more real-world objects may be part of activating or deactivating a spatial volume corresponding to the at least one of the one or more real-world objects. An extended reality view is displayed on the at least one display while overlaying, on the extended reality view, a representation of at least a portion of the at least one real-world object or the at least one spatial volume in one of multiple modes that each show the representation differently (operation 1704). The one of the multiple modes may depend upon a user distance from the at least one of the one or more real-world objects, a user setting for immersion safety, or both.

Although FIG. 17 illustrates another example of a process 1700 for providing a passthrough view of obstacles in the surrounding real-world environment for an immersive headset user, various changes may be made to FIG. 17. For example, while shown as a series of steps, various steps in FIG. 17 could overlap, occur in parallel, occur in a different order, or occur any number of times (including zero times).

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining real-time video captured using one or more imaging sensors of an immersive headset;
processing the real-time video to identify one or more real-world objects and render the one or more real-world objects on at least one display of the immersive headset;
allowing a user of the immersive headset to select at least one of the one or more real-world objects or at least one spatial volume containing the at least one real-world object; and
displaying an extended reality view on the at least one display while overlaying, on the extended reality view, a representation of at least a portion of the at least one real-world object or the at least one spatial volume in one of multiple modes that each show the representation differently.

2. The method of claim 1, wherein the multiple modes include:
a safety mode in which, when one of the one or more real-world objects is within a first distance from the immersive headset, the representation includes an entirety of the one of the one or more real-world objects;
a moderate mode in which, when the one of the one or more real-world objects is within a second distance from the immersive headset, the representation includes only an outline of the one of the one or more real-world objects, the first distance shorter than the shorter distance; and
a balanced mode in which, when the one of the one or more real-world objects is within the second distance from the immersive headset, the representation includes the entirety of the one of the one or more real-world objects.

3. The method of claim 1, wherein the multiple modes include:
a safety mode in which the representation includes an entirety of one of the one or more real-world objects;
a moderate mode in which the representation includes only an outline of the one of the one or more real-world objects, wherein the one of the one or more real-world objects is within a specified distance from the immersive headset; and
a balanced mode in which the representation includes the entirety of the one of the one or more real-world objects, wherein the one of the one or more real-world objects is within the specified distance from the immersive headset.

4. The method of claim 1, further comprising:
providing a user interface that allows the user to select the one of the multiple modes.

5. The method of claim 4, wherein the user interface comprises a slider that allows the user to adjust a degree of displaying the at least one selected real-world object or the at least one selected spatial volume.

6. The method of claim 1, wherein processing the real-time video to identify the one or more real-world objects comprises at least one of:
enabling the user to manually place at least one volume shape over at least one of the one or more real-world objects;
suggesting at least one volume shape for at least one of the one or more real-world objects to the user; or
automatically placing at least one volume shape over at least one of the one or more real-world objects.

7. The method of claim 1, wherein processing the real-time video to identify the one or more real-world objects comprises:
providing a user interface that allows the user to modify at least one volume shape placed over at least one of the one or more real-world objects by at least one of translation, rotation, or scaling of the at least one volume shape.

8. An electronic device comprising:
one or more imaging sensors;
at least one display; and
at least one processing device configured to:
obtain real-time video captured using the one or more imaging sensors;
process the real-time video to identify one or more real-world objects;
render the one or more real-world objects on the at least one display;
allow a user to select at least one of the one or more real-world objects or at least one spatial volume containing the at least one real-world object; and
initiate display of an extended reality view on the at least one display while overlaying, on the extended reality view, a representation of at least a portion of the at least one real-world object or the at least one spatial volume in one of multiple modes that each show the representation differently.

9. The electronic device of claim 8, wherein the multiple modes include:
a safety mode in which, when one of the one or more real-world objects is within a first distance from the electronic device, the representation includes an entirety of the one of the one or more real-world objects;
a moderate mode in which, when the one of the one or more real-world objects is within a second distance from the electronic device, the representation includes only an outline of the one of the one or more real-world objects, the first distance shorter than the shorter distance; and
a balanced mode in which, when the one of the one or more real-world objects is within the second distance from the electronic device, the representation includes the entirety of the one of the one or more real-world objects.

10. The electronic device of claim 8, wherein the multiple modes include:
a safety mode in which the representation includes an entirety of one of the one or more real-world objects;
a moderate mode in which the representation includes only an outline of the one of the one or more real-world objects, wherein the one of the one or more real-world objects is within a specified distance from the electronic device; and
a balanced mode in which the representation includes the entirety of the one of the one or more real-world objects, wherein the one of the one or more real-world objects is within the specified distance from the electronic device.

11. The electronic device of claim 8, wherein the at least one processing device is further configured to provide a user interface that allows the user to select the one of the multiple modes.

12. The electronic device of claim 11, wherein the user interface comprises a slider that allows the user to adjust a degree of displaying the at least one selected real-world object or the at least one selected spatial volume.

13. The electronic device of claim 8, wherein, to process the real-time video to identify the one or more real-world objects, the at least one processing device is configured to at least one of:
enable the user to manually place at least one volume shape over at least one of the one or more real-world objects;
suggest at least one volume shape for at least one of the one or more real-world objects to the user; or
automatically place at least one volume shape over at least one of the one or more real-world objects.

14. The electronic device of claim 8, wherein, to process the real-time video to identify the one or more real-world objects, the at least one processing device is configured to provide a user interface that allows the user to modify at least one volume shape placed over at least one of the one or more real-world objects by at least one of translation, rotation, or scaling of the at least one volume shape.

15. A non-transitory machine readable medium containing instructions that when executed cause at least one processor of an electronic device to:
obtain real-time video captured using one or more imaging sensors;
process the real-time video to identify one or more real-world objects;
render the one or more real-world objects on at least one display;
allow a user to select at least one of the one or more real-world objects or at least one spatial volume containing the at least one real-world object; and
initiate display of an extended reality view on the at least one display while overlaying, on the extended reality view, a representation of at least a portion of the at least one real-world object or the at least one spatial volume in one of multiple modes that each show the representation differently.

16. The non-transitory machine readable medium of claim 15, wherein the multiple modes include:
a safety mode in which, when one of the one or more real-world objects is within a first distance from the electronic device, the representation includes an entirety of the one of the one or more real-world objects;
a moderate mode in which, when the one of the one or more real-world objects is within a second distance from the electronic device, the representation includes only an outline of the one of the one or more real-world objects, the first distance shorter than the shorter distance; and
a balanced mode in which, when the one of the one or more real-world objects is within the second distance from the electronic device, the representation includes the entirety of the one of the one or more real-world objects.

17. The non-transitory machine readable medium of claim 15, wherein the multiple modes include:
a safety mode in which the representation includes an entirety of one of the one or more real-world objects;
a moderate mode in which the representation includes only an outline of the one of the one or more real-world objects, wherein the one of the one or more real-world objects is within a specified distance from the electronic device; and
a balanced mode in which the representation includes the entirety of the one of the one or more real-world objects, wherein the one of the one or more real-world objects is within the specified distance from the electronic device.

18. The non-transitory machine readable medium of claim 15, further containing instructions that when executed cause the at least one processor to provide a user interface that allows the user to select the one of the multiple modes;
wherein the user interface comprises a slider that allows the user to adjust a degree of displaying the at least one selected real-world object or the at least one selected spatial volume.

19. The non-transitory machine readable medium of claim 15, wherein the instructions that when executed cause the at least one processor to process the real-time video to identify the one or more real-world objects comprise:
instructions that when executed cause the at least one processor to at least one of:
enable the user to manually place at least one volume shape over at least one of the one or more real-world objects;
suggest at least one volume shape for at least one of the one or more real-world objects to the user; or
automatically place at least one volume shape over at least one of the one or more real-world objects.

20. The non-transitory machine readable medium of claim 15, wherein the instructions that when executed cause the at least one processor to process the real-time video to identify the one or more real-world objects comprise:
instructions that when executed cause the at least one processor to provide a user interface that allows the user to modify at least one volume shape placed over at least one of the one or more real-world objects by at least one of translation, rotation, or scaling of the at least one volume shape.
